(19) United States
(12) Patent Application Publication
(10) Pub. No.: US 2003/0033742 A1
(43) Pub. Date: Feb. 20, 2003

(54) Safety device having cone containing material

(75) Inventors: Thomas Perelli, Winchester, VA (US); Craig Demko, Winchester, VA (US); Raymond L. Fedeli, Altoona, PA (US)

Correspondence Address: FOLEY AND LARDNER, SUITE 500, 3000 K STREET NW, WASHINGTON, DC, 20007, US

(73) Assignee: Rubbermaid Commercial Products LLC

(21) Appl. No.: 10/101,708

(22) Filed: Mar. 21, 2002

Related U.S. Application Data
(63) Continuation-in-part of application No. 09/931,074, filed on Aug. 17, 2001.
Application No. 09/931,074 is a continuation-in-part of application No. 60/330,878, filed on Nov. 1, 2001.

(51) Int. Cl. G09F 15/00; G08B 1/00; G01D 11/00; G01D 13/00; G09F 9/00; A47B 41/00; G09B 1/00

(52) U.S. Cl. 40/606; 116/63 C; 116/201; 116/306; 434/433

(57) ABSTRACT

A safety device includes a material, and a cone holding the material and having an opening from which the material can be dispensed. The material can have absorbent properties and/or can be configured to warn of a hazard by displaying cautionary information. A hazard can be addressed by providing the cone containing the material within an area prone to hazards, and, after a hazard is created within the area, removing material from the cone and placing the material on the hazard.

### CROSS-REFERENCE TO RELATED APPLICATION

This application claims the benefit of U.S. application Ser. No. 09/931,074, filed Aug. 17, 2001, and this application also claims the benefit of U.S. Provisional Application No. 60/330,878, filed Nov. 1, 2001.

### BACKGROUND OF THE INVENTION

1. Field of the Invention

This invention relates to a safety device and, more particularly, to a cone containing material having absorbent properties and/or displaying cautionary information.

2. Description of Related Art

Public areas that experience heavy pedestrian traffic are often prone to hazards, such as spilled foodstuffs and broken containers. Examples of such areas include grocery stores, hospitals, amusement parks, movie theaters, shopping malls, cafeterias, restaurants, shopping centers, stables, and stadiums.

Hazards can remain in place for very undesirable lengths of time. A hazard usually will remain untouched until an employee removes it. For this to happen, however, an employee must first become aware of the hazard, which may take a considerable amount of time. Even after the employee notices the hazard, the employee typically will require a period of time to obtain the equipment needed to clean up the spill.

Unattended hazards can endanger pedestrians. Sometimes pedestrians do not notice a hazard or do not take the necessary steps to avoid it. For example, slip-and-fall injuries occur in supermarkets when hazards are present in an aisle. Also, unattended hazards may be spread by a pedestrian, thus increasing the risk to others.

Unattended hazards also can create perception problems. For example, whether a customer will choose to shop in a store may depend in large part on that customer's perception of the shopping environment. If unattended spills and other hazards are present, the customer may believe that the store has no commitment to cleanliness or that shopping there may be dangerous.

Signs have been used to warn of a hazard. For example, a foldable sign bearing the words “Caution Wet Floor” may be placed near a spill. Warning signs, however, typically are not stored in areas that experience heavy pedestrian traffic. Rather, the signs are maintained in locations inaccessible to the public, such as supply rooms. Thus, an undesirable period of time may pass before the sign is positioned to warn of the hazard.

Even when in place, warning signs do not eliminate the possibility of pedestrians contacting the hazard. Warning signs may be placed over a hazard, but they often do not completely cover the hazard. Also, a warning sign may be accidentally bumped and pushed away from the hazard. Sometimes the sign is placed adjacent to the hazard to avoid soiling the sign. A passerby approaching the sign may avoid the sign yet still contact the hazard.

### SUMMARY OF THE INVENTION

An aspect of the present invention relates to a safety device that includes a material having absorbent properties and a cone holding the material. The cone has an opening from which the material can be dispensed. The material can be configured as a roll that includes separable mats.

Another aspect of the present invention relates to a safety device that includes a material configured to warn of a hazard by displaying cautionary information and a cone holding the material. The cone has an opening from which the material can be dispensed. The material can be configured as a roll that includes separable mats. The cautionary information on the material can be at least one of cautionary language, a color associated with hazard warnings, and a cautionary symbol.

Yet another aspect of the present invention relates to a method of addressing a hazard. The method includes the steps of providing, within an area prone to hazards, a cone containing a material, and, after a hazard is created within the area, removing material from the cone and placing the material on the hazard. The cone can be moved nearer to the hazard after the hazard is created within the area. Additionally, the hazard can be removed after the material has been placed on the hazard.

Yet another aspect of the present invention relates to a safety device including a dispenser, a plurality of mats held by the dispenser and including a single layer of absorbent material, and cautionary information displayed on the single layer of absorbent material of the mats.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate preferred embodiments of the invention and together with the description, serve to explain the principles of the invention.

FIG. 1 is a perspective view of a safety device according to a first embodiment of the present invention.

FIG. 2 is a perspective view of a mat of a material of the safety device of FIG. 1.

FIG. 3 is a perspective view of a roll of material of the safety device of FIG. 1.

FIG. 4 is a cross-sectional view of the safety device of FIG. 1.

FIG. 5 is a perspective view of an upper bracket, a lower bracket, and a roll of material of the safety device of FIG. 1.

FIG. 6 is a bottom perspective view of the safety device of FIG. 1.

FIG. 7 is a perspective view of a safety device according to a second embodiment of the present invention.

FIG. 8 is a perspective view of a winding knob, a core rod, a collar, a lower bracket, and a roll of material of the safety device of FIG. 7.

FIG. 9 is a bottom perspective view of the safety device of FIG. 7.

### DETAILED DESCRIPTION OF THE PREFERRED EMBODIMENTS

Reference will now be made in detail to presently preferred embodiments of the invention, which are illustrated in the accompanying drawings. An effort has been made to use the same reference numbers to refer to the same or like parts.

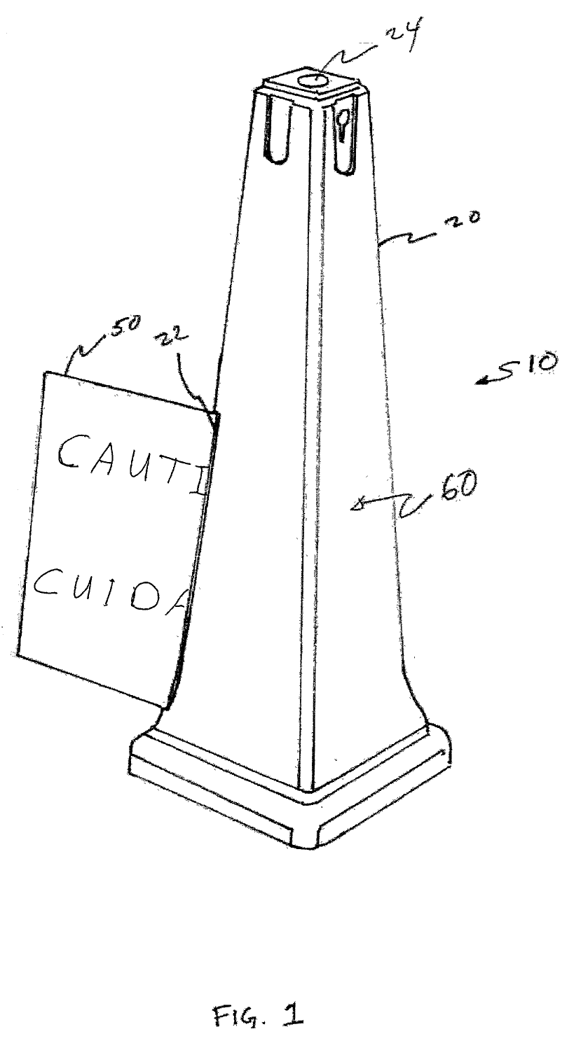

The present invention relates to a safety device including a dispenser, such as a cone, and material disposed in the dispenser. A first preferred embodiment of such a safety device 10 is shown in FIG. 1. The safety device 10 has material 50 stored within cone 20. The material 50 can be pulled from the cone 20 to clean up and/or warn of hazards. In this preferred embodiment, the material 50 is absorbent and is configured to warn of a hazard, although it is contemplated that the material 50 may have only one of the two properties.

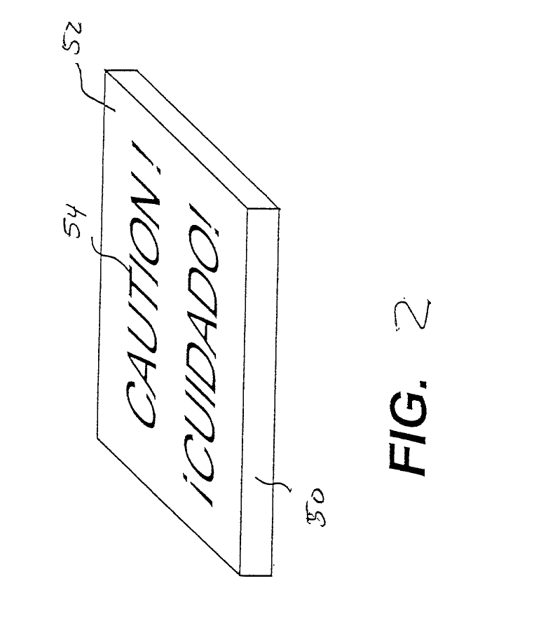

It is preferred that the material 50 be absorbent. Preferably the material 50 will absorb at least its weight in water, more preferably it will absorb at least twice its weight in water, even more preferably it will absorb at least four times its weight in water, even more preferably it will absorb at least 10.5 times its weight in water, and even more preferably it will absorb at least 12.5 times its weight in water. An example of such absorbent material 50 is produced by New Pig, Inc. under product number 6279. In this preferred embodiment, the absorbent material 50 consists of a single layer, as shown in FIG. 2.

The material 50 preferably is configured to warn of a hazard by displaying cautionary information. FIGS. 2 shows an example of material 50, which is configured to warn of a hazard by containing a warning portion 52 having cautionary information 54 thereon. The cautionary information 54 preferably is at least one of cautionary language (e.g., “caution,” “cuidado,” “actung,” “vorsicht,” etc.), a cautionary symbol (e.g., skull-and-crossbones, stop-sign, etc.), and a color associated with hazard warnings (e.g., bright yellow, bright red, or other eye-catching colors). The cautionary information could be a combination of some or all of the three types. The aforementioned examples for the cautionary information 54 are not intended to be limiting, and other language, symbols, and colors that serve the purpose of warning of a hazard can be used. In this preferred embodiment, the cautionary information is displayed on a single layer of absorbent material 50.

It is also preferred that the material 50 have sufficient thickness to serve as a protective barrier for a person cleaning a hazard. For example, if the hazard is broken glass, the material 50 preferably has sufficient thickness to protect the person cleaning the hazard from the glass. Listed in reverse order of preference, the preferred thicknesses of the material are between 0.017 and 0.5 inches, between 0.032 and 0.2 inches, and between 0.06 and 0.1 inches.

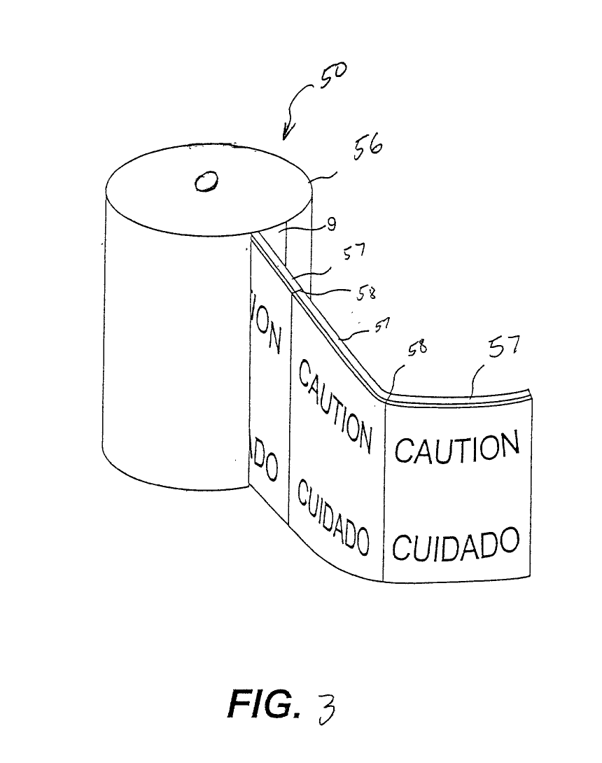

In this preferred embodiment, the material 50 is stored in a roll 56, as shown in FIG. 3. Preferably, the roll 56 contains a plurality of mats 57, and adjacent mats 57 on the roll 56 are connected to each other along areas or lines of weakness 58 that ease separation of adjacent mats. More preferably, the areas of weakness 58 are aligned perforations that allow a person to easily tear-off as many mats 57 as are needed while leaving the remainder of the mats 57 on the roll 56. Semicircular cut outs (not shown) may be provided at the ends of the areas of weakness 58 to facilitate the tearing process (when one mat is pulled away from a second mat). Although the areas of weakness 58 are preferred, the roll 56 could be a solid sheet of material 50 without such areas of weakness 58.

The material 50 can be held by a dispenser, such as a cone 20. As shown in FIG. 1, the cone 20 contains the material 50, with a lead portion of the material 50 extending outward through an opening, preferably a slot 22, in the cone 20. The illustrated cone 20 is four sided, but it could have other configurations, such as three sided or substantially conical. The cone 20 is a preferred dispenser because, among other things, it can be constructed to be impervious to liquid, rigid, highly noticeable, and easy to move. The cone 20, for example, includes an opening 24 at its top, which provides a grip for one-handed carrying of the cone 20.

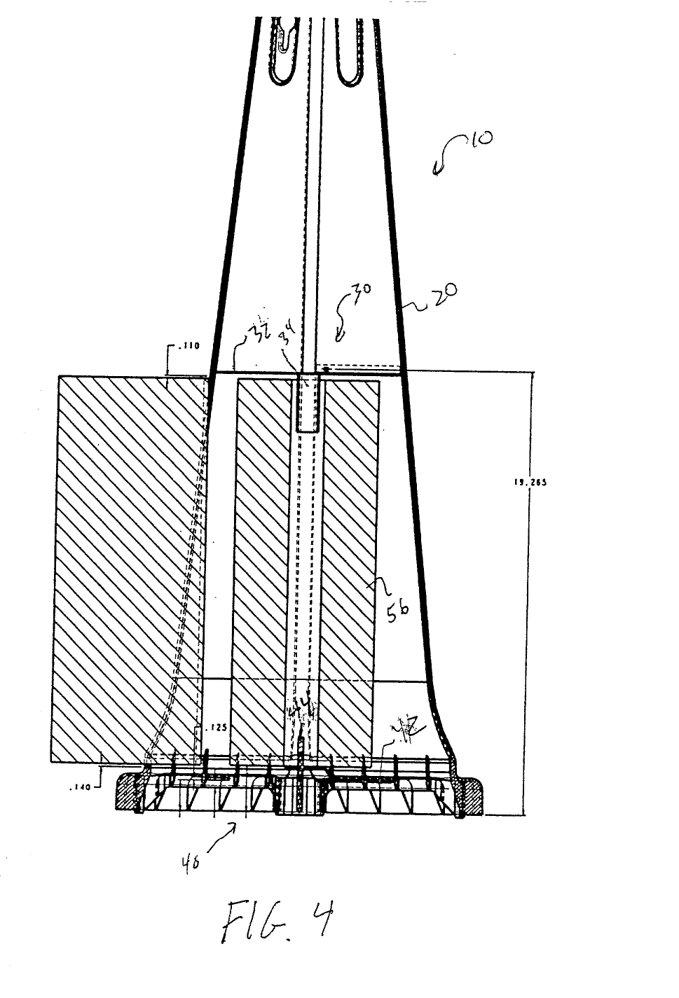

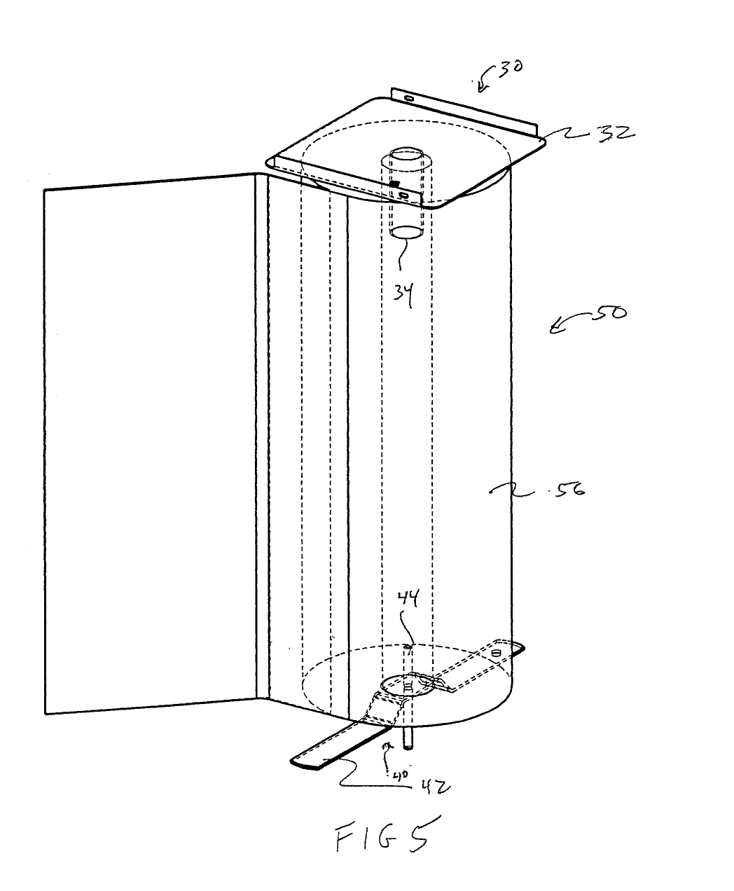

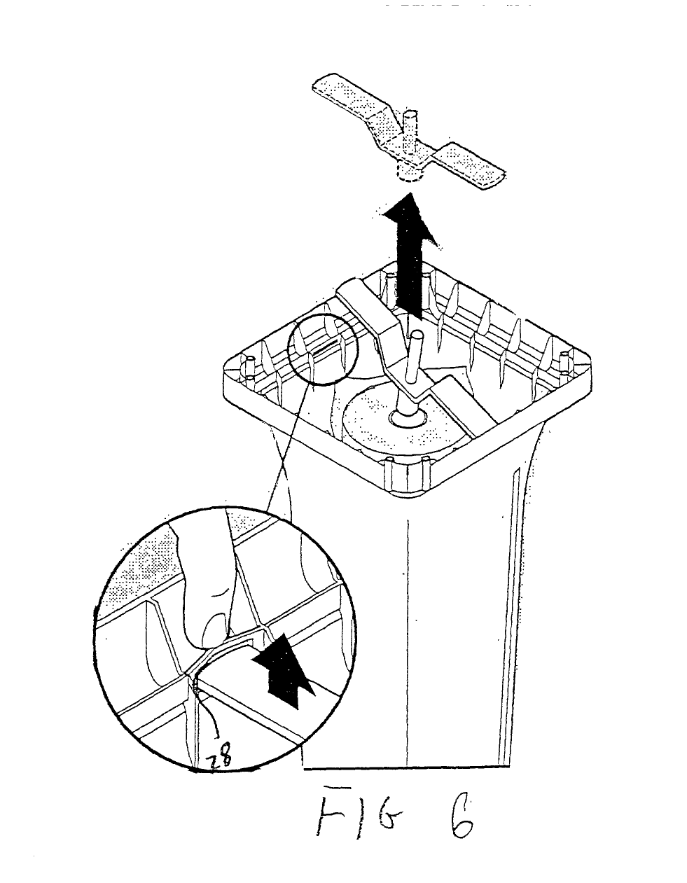

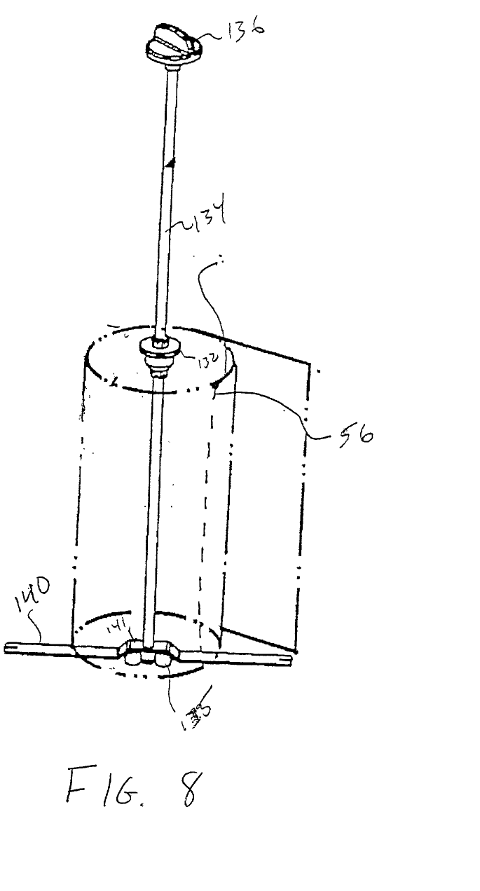

FIG. 4 shows the roll 56 of material 50 disposed within the cone 20. FIGS. 5 and 6 provide additional illustrations of the structure that holds the roll 56 in the cone 20. In particular, the cone 20 includes an upper support bracket 30 and a lower support bracket 40 for positioning the roll 56 within the cone 20. The upper support bracket 30 has a top plate 32 fixed to the cone 20 by conventional means and a pin 34 fixed to the top plate 32. The pin 34 extends into the center of the roll 56 to hold it in place. The lower support bracket 40 has a bar member 42 and a pin 44 that extends into the center of the roll 56. Ends of the bar member 42 fit within respective recesses 28 (see FIG. 8) in the cone 20 to hold the bar member 42 in the cone 20.

To insert a roll 56, the cone 20 is turned upside down with the top of the cone 20 resting on the floor. The user disengages one side of the bar member 42 from its recess 28 by applying outward pressure to the cone 20. After one side of the bar member 42 is disengaged from the cone 20, the other side can easily freed. If an old roll is present, it is removed and a new roll 56 is placed on the upper support bracket 30. The user can then feed the leading edge of the roll through the slot 22 in the cone 20. The lower support member 40 is then replaced by inserting the ends of the bar member 42 into the recesses 28 on the cone 20.

The cone 20 preferably is configured to warn of a hazard by displaying cautionary information. For example, the cone 20 can contain warning portion(s) 60 (see FIG. 1) having any or all of the cautionary information mentioned above with regard to the material 50, such as cautionary language, a cautionary symbol, and a color associated with hazard warnings.

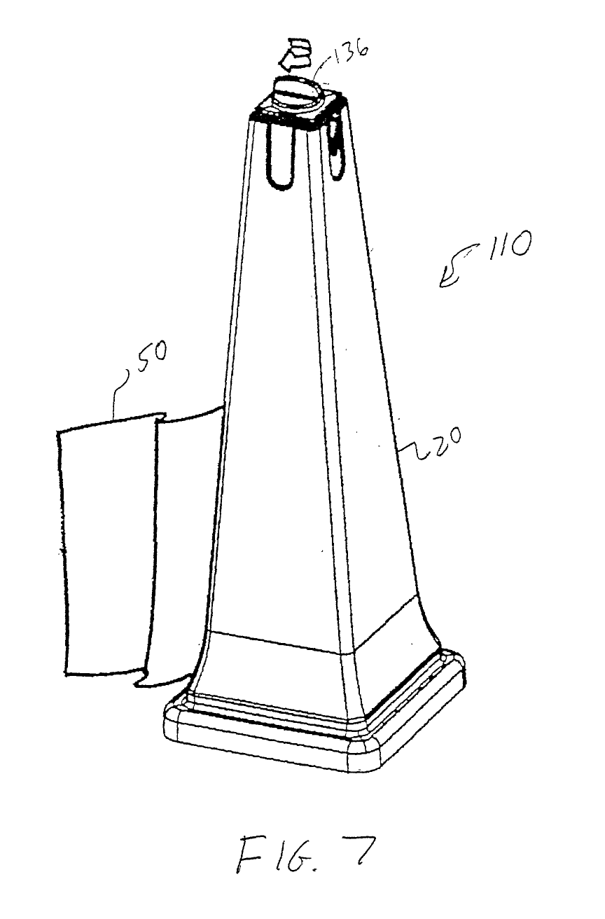

A second preferred embodiment of a safety device 110 in accordance with the present invention is shown in FIGS. 7 to 9. This embodiment is similar to the first embodiment in many respects.

In this second embodiment, however, instead of the upper support bracket 30, the safety device 110 has a collar 132 fitted on a rod 134 with a winding knob 136. The collar 132 can be screwed onto threads (not shown) of the rod 134 to fix the collar 132 in position or it can be fixed to a non-threaded rod by some other means. A lower end of the rod 134 extends through a hole in a lower support bracket 140 and is held in place by a wing nut 135 screwed onto threads (not shown) of the rod 134. The rod 134 could be held in place by other fasteners, such as a snap-on cap. An upper end of the rod 134 extends through a hole in the top of the cone 20, such that the winding knob 136 is exposed. The winding knob 136, rod 134, and collar 132 are fixed relative to one another, such that turning of the winding knob 136 causes a corresponding turning of the rod 134 and collar 132.

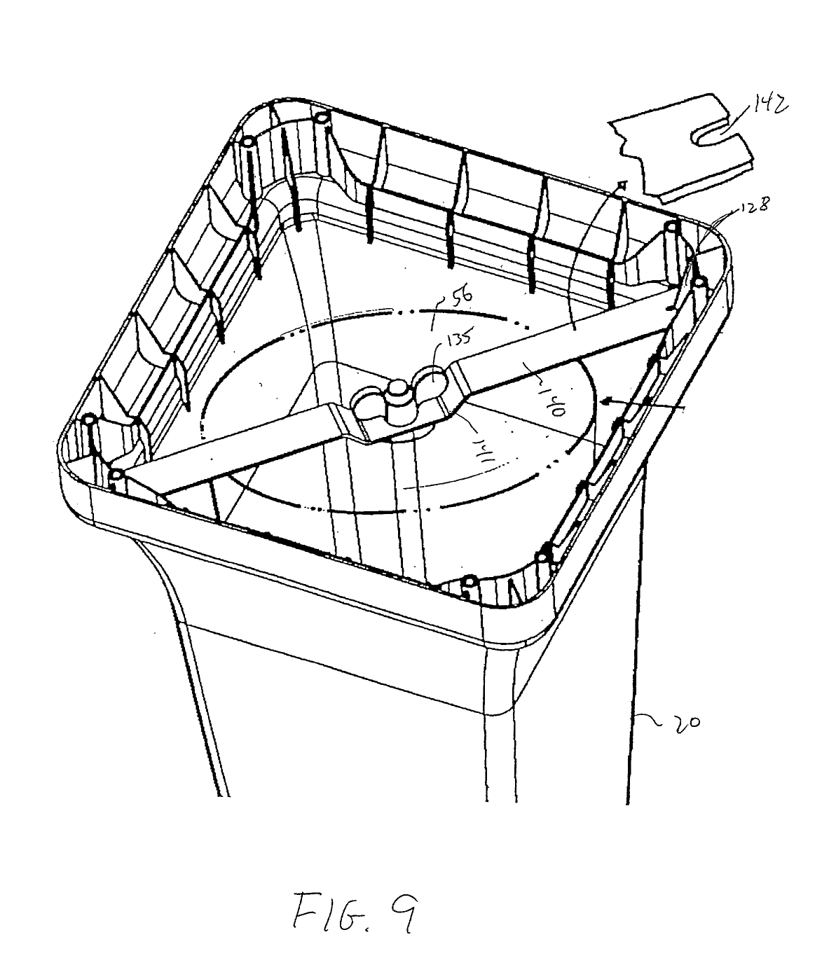

In the safety device 110 of this second preferred embodiment, the lower support bracket 140 differs from the lower support bracket 40 of the first embodiment. For example, the lower support bracket 140 has a stepped portion 141. Also, as shown in FIG. 9, the ends of the bracket 140 are held in place by placing slots 142, on the ends of the bracket 140, about vertical ribs 128 of the cone 20.

In this second embodiment, the roll 56 can be turned by turning the winding knob 136. A lower portion of the collar 132 is positioned against an upper portion of the roll 56. By tightening the wing nut 135 on the rod 134, the collar 132 is urged against the upper portion of the roll 56 with sufficient normal force to yield a frictional force that enables a user to turn the roll 56 (in the cone 20) by turning the winding knob 136. The collar 132 could have barbs or protrusions to increase the connection between the collar 132 and roll 56.

The safety device of the present invention permits easy clean up of a hazard and warning of a hazard at least until the hazard is removed. The hazard can be a variety of problems including, but not limited to, liquid, moisture, broken glass, foodstuffs, loose flooring, animal feces, and missing flooring.

For example, the safety device 10, 110 can be provided within an area prone to hazards. An area of this nature would include, but is not limited to, a grocery store, a hospital, an amusement park, a movie theater, a shopping mall, a cafeteria, a restaurant, a shopping center, a stable, and a stadium. Preferably the safety device 10, 110 is placed in an area where patrons have ready access to it. For example, the safety device 10, 110 could be placed in an aisle of a grocery store, a hallway of a hospital, a walkway of an amusement park, a lobby of a movie theater, a common area of a shopping mall, or a dining area of a cafeteria or a restaurant.

After a hazard is created within that area, a person could remove material 50 from the cone 20 and use it to clean the hazard. The person also could move the cone 20 near the hazard while cleaning it, to provide warning of the hazard. Additionally, with or without moving the cone 20 near the hazard, a person could remove a mat 57 from it, and place the removed mat 57 on the hazard thereby providing a warning of the hazard to, e.g., a subsequent passerby. This person may be, for example, a customer in a grocery store. The mat 57 could be left on the hazard until a second person, e.g., an employee of the grocery store, removes the hazard.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A safety device comprising:
a material having absorbent properties; and
a cone holding the material and having an opening from which the material can be dispensed.

2. The safety device of claim 1, wherein the material is configured as mats.

3. The safety device of claim 1, wherein the material is configured as a roll.

4. The safety device of claim 3, wherein the roll of material comprises a plurality of mats, and adjacent mats on the roll are connected to each other along areas of weakness that ease separation of the adjacent mats.

5. The safety device of claim 1, wherein the material is configured to warn of a hazard by displaying cautionary information.

6. The safety device of claim 1, wherein the cone houses the material.

7. The safety device of claim 1, wherein the opening comprises a slot in a side of the cone.

8. The safety device of claim 1, wherein the cone includes a lower support bracket for positioning the material within the cone.

9. The safety device of claim 8, wherein the cone includes at least one recess for receiving the lower support bracket in a snap-fit connection.

10. The safety device of claim 8, wherein the cone includes an upper support bracket for positioning the material within the cone.

11. The safety device of claim 1, wherein the cone is configured to warn of a hazard by at least one of displaying cautionary language, displaying a color associated with hazard warnings, and displaying a cautionary symbol.

12. A safety device comprising:
a material configured to warn of a hazard by displaying cautionary information; and
a cone holding the material and having an opening from which the material can be dispensed.

13. The safety device of claim 12, wherein the cautionary information on the material is at least one of cautionary language, a color associated with hazard warnings, and a cautionary symbol

14. The safety device of claim 12, wherein the material is configured as mats.

15. The safety device of claim 12, wherein the material is configured as a roll.

16. The safety device of claim 15, wherein the roll of material comprises a plurality of mats, and adjacent mats on the roll are connected to each other along areas of weakness that ease separation of the adjacent mats.

17. The safety device of claim 12, wherein the cautionary information is at least one of cautionary language, a color associated with hazard warnings, and a cautionary symbol.

18. The safety device of claim 12, wherein the cone houses the material.

19. The safety device of claim 12, where the opening comprises a slot in a side of the cone.

20. The safety device of claim 12, wherein the cone includes a lower support bracket for positioning material within the cone.

21. The safety device of claim 20, wherein the cone includes at least one recess for receiving the lower support bracket in a snap-fit connection.

22. The safety device of claim 20, wherein the cone includes an upper support bracket for positioning material within the cone.

23. The safety device of claim 12, wherein the cone is configured to warn of a hazard by at least one of displaying cautionary language, displaying a color associated with hazard warnings, and displaying a cautionary symbol.

24. A method of addressing a hazard, the method comprising the steps of:
providing, within an area prone to hazards, a cone containing a material;
after a hazard is created within the area, removing material from the cone and placing the material on the hazard.

25. The method of claim 24, further comprising the step of moving the cone nearer to the hazard after the hazard is created within the area.

26. The method of claim 24, further comprising the step of removing the hazard after the material has been placed on the hazard.

27. The method of claim 26, wherein a first person performs both the step of removing the material from the cone and placing the material on the hazard, and the step of removing the hazard.

28. The method of claim 26, wherein a first person performs the step of removing material from the cone and placing the material on the hazard, and a second person performs the step of removing the hazard.

29. The method of claim 24, wherein the material contains cautionary information to warn of the hazard.

30. The method of claim 29, wherein the cautionary information is at least one of cautionary language, a color associated with hazard warnings, and a cautionary symbol.

31. The method of claim 24, wherein the cone contains cautionary information to warn of the hazard.

32. The method of claim 31, wherein the cautionary information is at least one of cautionary language, a color associated with hazard warnings, and a cautionary symbol.

33. A safety device comprising:
a dispenser;
a plurality of mats held by the dispenser and including a single layer of absorbent material; and
cautionary information displayed on the single layer of absorbent material of the mats.

34. The safety device of claim 33, wherein the dispenser is a cone.

35. The safety device of claim 33, wherein the mats include areas of weakness along which the mats can be torn to remove them from the dispenser

36. The safety device of claim 35, wherein the mats are in a roll and the areas of weakness are disposed between adjacent mats.
